(19) United States
(12) Patent Application Publication
(10) Pub. No.: US 2005/0239482 A1
(43) Pub. Date: Oct. 27, 2005

(54) METHOD OF BLOCKING COMMUNICATIONS

(76) Inventors: Chen-Huang Fan, Miao- Li Hsien (TW); Sheng-Yi Chiu, Taipei City (TW); Chao-Yuan Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/907,858

(22) Filed: Apr. 19, 2005

(30) Foreign Application Priority Data
Apr. 19, 2004 (TW) 093110848

(51) Int. Cl. H04Q 7/20

(52) U.S. Cl. 455/456.4

(57) ABSTRACT

BCCH signals are emitted from a communication-blocking device with higher power according to system data got from base stations. TMSI of mobile subscribers is collected. Paging of the mobile subscriber is monitored. When it is determined that a mobile subscriber is to receive a call, the communication-blocking device sends blocking RA in all time slots, making the mobile subscriber fail to get the call.

### BACKGROUND OF INVENTION

1. Field of the Invention

The present invention relates to a method of blocking communications, and more particularly, to a method of blocking communications for some specific mobile subscribers.

2. Description of the Prior Art

Wireless communications play an important role in the modern society, and GSM (Global System for Mobile communication) is the most popular communication system today. GSM makes it easier for people to communicate with others in any place where the signal can reach.

Please refer to FIG. 1, which illustrates a wireless communication system 10. A wireless communication system comprises a plurality of cells where base stations provide the service. For convenience of description, the communication system 10 comprises a cell 12 and a cell 20, where a base station 14 provides service in the cell 12 and a base station 18 provides service in the cell 20. Both the cell 12 and the cell 20 comprise a mobile subscriber 16, which is used to transmit and receive wireless signals and communications with the base stations 14,18. Because the mobile subscriber 16 is located in both of the cells 12 and 20, the mobile subscriber 16 can communicate with both of the base stations 14 and 18. In general, the mobile subscriber 16 usually selects one base station having strong signals as the serving cell to camp on. If the signals of each base station received by the mobile subscriber 16 change because the mobile subscriber 16 is moving, the mobile subscriber 16 will reselect a cell.

Although the present communication system is convenient, there are some disadvantages. For example, in some public occasions, such as in a movie theater, in a lecture hall, or in a class, cell phone users often forget to turn off their cell phones or switch their cell phones into a vibration mode, so ringing of a phone call will bother other people. In the prior art, electromagnetic waves for distortion are used in a concert to blocking the communication. However, the method not only blocks a user from receiving a call, but also prevents the user from calling others. Accordingly, a communication system should be designed to only block receiving a call.

### SUMMARY OF INVENTION

It is therefore a primary objective of the claimed invention to provide a wireless communication system designed to only block receiving a call.

A method used in a communication-blocking unit for preventing a base station from establishing communications with a mobile subscriber includes receiving a first BCCH signal emitted by the base station and reading system information from the BCCH signal. A second BCCH signal is sent in a specific area according to the system information. Identity of the mobile subscriber is collected for the specific area. A CCCH signal is received, and if the CCCH signal has the identity, a blocking RA is sent during a predetermined time period.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a wireless communication system.

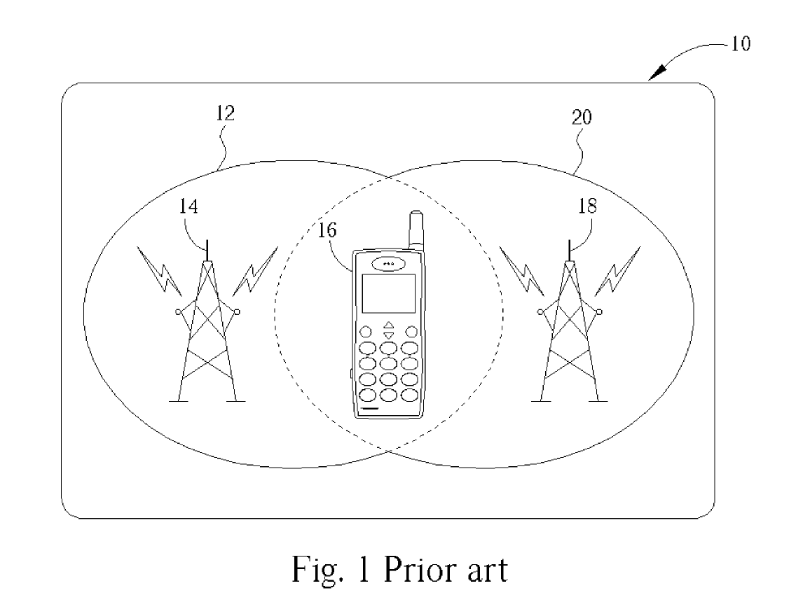

FIG. 2 illustrates communications between a communication-blocking device, a base station, and a mobile subscriber according to the present invention.

FIG. 3 illustrates a flowchart of the method of blocking communications according to the present invention.

FIG. 4 illustrates a communication-blocking device according to the present invention.

### DETAILED DESCRIPTION

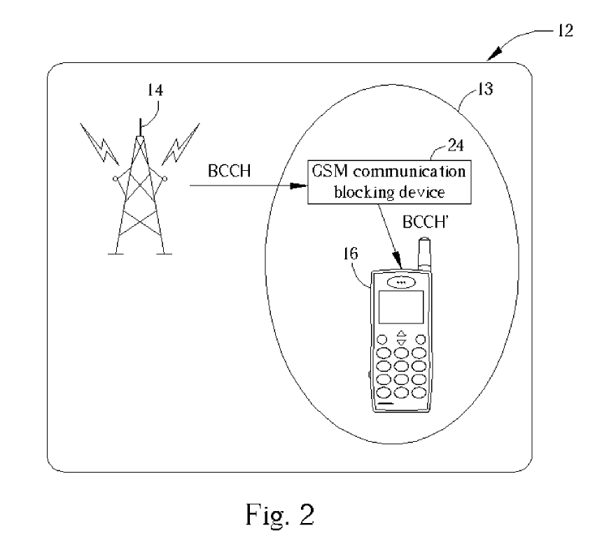

Please refer to FIG. 2, which illustrates communication between a communication-blocking device 24, a base station 14, and a mobile subscriber 16 according to the present invention. The service area of the base station 14 is the cell 12. The cell 12 covers the mobile subscriber 16 and the communication-blocking device 24. The base station 14 emits an identity signal of the base station 14 by a BCCH (Broadcast Control Channel). The identity includes MCC (Mobile Country Code), MNC (Mobile Network Code), and LAC (Location Area Code). The mobile subscriber 16 will check the identity signal on the BCCH, and the communication-blocking device 24 also gets a wanted identity signal or other information from the BCCH. The related data of the base station 14 is then stored in the communication-blocking device 24 for simulation of the base station 14.

The communication-blocking device 24 simulates the base station 14 according to the information got from the base station 14 and sends the same BCCH signal (like BCCH′ in FIG. 2) to a cell 13. The communication-blocking device 24 will first measure the signal power emitted from the base station 14 so that when the communication-blocking device 24 emits the BCCH′ signal, the power of the BCCH′ signal will be stronger in the cell 13 than that of the BCCH signal emitted from the base station 14.

When the mobile subscriber 16 enters the cell 13, it will receive the BCCH signal from the base station 14 as well as the BCCH′ signal from the communication-blocking device 24. Because the mobile subscriber 16 will receive a stronger signal emitted from the communication-blocking device 24, the communication-blocking device 24 will be considered as another base station. The mobile subscriber 16 starts to camp on the communication-blocking device 24 and sends its recognition 21 to the communication-blocking device 24. The recognition 21 is usually a TMSI (Temporary Mms Identity) in a GSM system.

Then, the communication-blocking device 24 keeps monitoring the mobile subscriber 16. If the base station 14 sends a call to the mobile subscriber 16, both the communication-blocking device 24 and the mobile subscriber 16 will detect the call. The communication-blocking device 24 checks the blocking list and determines if the mobile subscriber 16 is on the blocking list. If it is confirmed to block the mobile subscriber 16, the communication-blocking device 24 will send fake blocking RA signals in each RA time slot during a predetermined time T. Therefore, when the base station 14 receives both the RA signals from the communication-blocking device 24 and the mobile subscriber 16, the base station 14 will ignore the invalid RA signals because two RA signals collide and distort each other. The mobile subscriber 16 will not communicate with the base station 14. The predetermined time T should be larger than the time during which the mobile subscriber 16 keeps connecting with the base station 14.

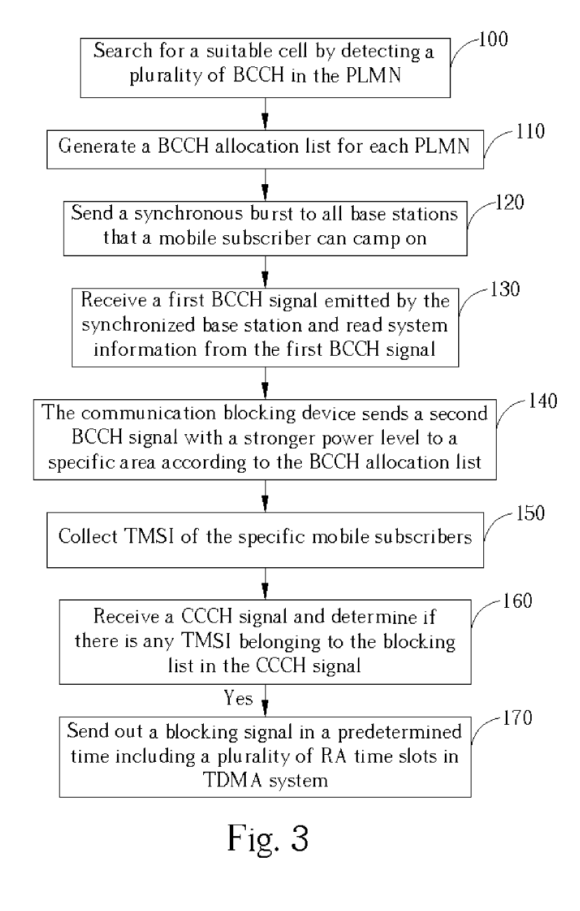

Please refer to FIG. 3, which illustrates a flowchart of the method of blocking communications according to the present invention. A communication-blocking device implements the method of blocking communications. In step 100, cell selection or re-selection is executed. The communication-blocking device, like a mobile subscriber, has to choose one suitable base station of higher power to connect. The procedure of choosing a suitable base station according to the power of a BCCH signal is called cell selection.

Cells are selected according to two parameters C1 and C2, which are defined by ETSI 05.08. The definition of C1 is: C1=(A−Max(B,0)); where A=RLA_C−RXLEV_ACCESS_MIN; RLA_C is the average power of the signal carrier; RXLEV_ACCESS_MIN is the minimal power that a mobile subscriber is able to connect to a communication system; B=mobile subscriber_TXPWR_MAX_CCH−P; mobile subscriber_TXPWR_MAX_CCH is the maximal power that BCCH does not undergo power control; and P is the maximal output power of a mobile subscriber.

If the C1 of a cell is zero, it means the cell is suitable for a mobile subscriber to camp on. The cell having the greatest C1 will be selected to be the cell for the mobile subscriber to camp on. If a mobile subscriber is moving, the C1 of the moving mobile subscriber keeps changing. Thus, the parameter C2 is needed to select a cell. C2 is defined as follows:
C2=C1+CELL_{—}RESELECTION_{—}OFFSET−TEMPORARY OFFSET*H(PENALTY_{—}TIME−T); PENALTY_{—}TIME< >11111, where for a non-serving cell, H(x)=0 for x<0 and H(x)=1 for x≧0; for a serving cell, H(x)=0.

In step 100, a search is conducted for a suitable cell by detecting a plurality of BCCH in the PLMN according to the rule of the cell selection mentioned above.

In step 110, the power of all BCCH that a mobile subscriber can camp on is measured and a BCCH allocation list is obtained for each PLMN according to the measured power of these BCCH. In step 120, a synchronous burst is sent to all base stations that a mobile subscriber can camp on (according to step 100) so that the base stations can be synchronized. In step 130, a first BCCH signal emitted by the synchronized base station is received, and system information is read from the received first BCCH signal.

As mentioned above, when a mobile subscriber is camping on a base station, MCC, MNC, and LAC have to be checked. The method of blocking communications in the present invention takes advantage of a communication-blocking device, which simulates a fake base station, so that a mobile subscriber in a predetermined cell will send its recognition to the fake base station. Therefore, in step 130, the system information in the first BCCH is read for simulating a fake base station.

In step 110, a BCCH allocation list is generated for each PLMN. In step 140, the communication-blocking device sends a second BCCH signal with a stronger power level to a specific area according to the BCCH allocation list. The second BCCH signal carries system information obtained in step 130. The communication-blocking device is like a base station in the specific area at this time and the power of the signals that the communication-blocking device emits is stronger than that of the signals emitted by other base stations in the same specific area. Notice that the power of the first BCCH signal is greater than other BCCH signals in that area, and the power of the second BCCH signal is greater than the first BCCH signal. Therefore, the mobile subscriber in this specific area will camp on the communication-blocking device and send its recognition to the communication-blocking device.

The method of the present invention is to enable blocking of communications for some specific mobile subscribers. In step 150, TMSI of the specific mobile subscribers is collected. In step 160, a CCCH signal is received and it is determined if there are any TMSI belonging to the blocking list in the CCCH signal. When it is found that a base station tries to send a call to a mobile subscriber on the blocking list, then in step 170, a blocking signal is sent out in a predetermined time including a plurality of RA time slots in the TDMA system. Therefore, the blocking signal will collide with RA signals of the mobile subscriber, so the connection between the base station and the mobile subscriber will fail. The predetermined time should be larger than the time during which the mobile subscriber keeps connecting with the base station. In other words, the times for which the mobile subscriber tries to connect to the base station are fewer than the number of RA time slots in which blocking signals are sent. Therefore, although the base station calls the mobile subscriber, a connection is not established due to failure of authorization. After all TMSI of the mobile subscribers of all PLMN are collected, the communication-blocking device stops broadcasting. A mobile subscriber can still call out. The flowchart of FIG. 3 is a preferred embodiment, and the sequence of each step can be changed according to different situations.

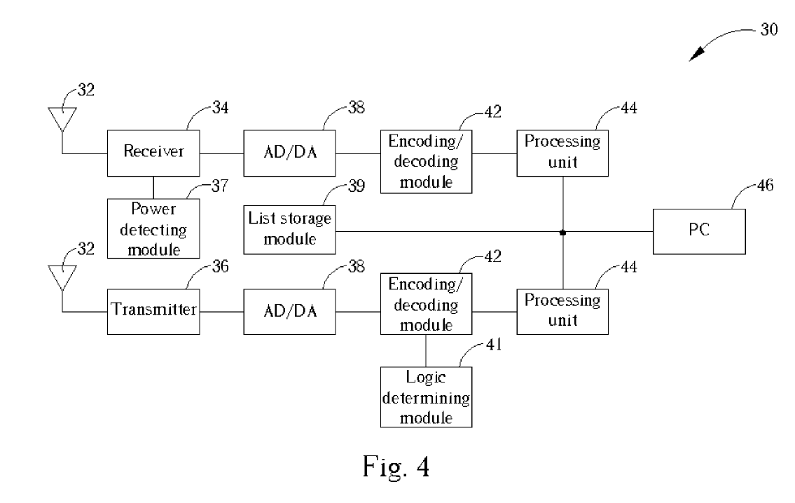

Please refer to FIG. 4, which illustrates the communication-blocking device 30 according to the present invention. The communication-blocking device 30 comprises an antenna 32, a receiver 34, a transmitter 36, a power detecting module 37, an AD/DA converter 38, a list storage module 39, a logic determining module 41, an encoding/decoding module 42, a processing unit 44, and a PC 46. The receiver 34 and the transmitter 36 receive and transmit wireless signals through the antenna 32, respectively. What the receiver 34 receives includes a BCCH signal and a CCCH signal that a base station emits. The transmitter 36 is used to send a blocking signal and a second BCCH signal in a specific area. The second BCCH signal is the BCCH signal emitted from the base station. In other words, the transmitter 36 performs step 140 and step 190 of FIG. 3, sending the second BCCH signal with a stronger power level in a predetermined area and sending blocking RA in the predetermined time.

The list storage module 39 is used to store a blocking list. The power detecting module 37 connected to the receiver 34 is used to detect power of the BCCH signal emitted by a base station. The processing unit 44 stores TMSI of mobile subscribers in the blocking list, and is also involved in steps 100, 120, 130, and 170 in FIG. 3. The logic determining module 41 related to step 160 in FIG. 3 is used to determine to send a blocking RA according to the blocking list stored in the list storage module 39 and the CCCH signal received by the receiver 34. The AD/DA converter 38 is used to transform signals between analog and digital types. The encoding/decoding module 42 encodes/decodes the signals of the receiver 34 and/or the transmitter 36. The communication-blocking device of the present invention can block calls from a base station to a mobile subscriber in a GSM communication system.

To avoid the ringing of mobile subscribers bothering other people in a public place or in some special occasion, the present invention proposes a method and a communication-blocking device to block communications for some specific users. The method first obtains system information from a base station, and simulates the base station. Then, it broadcasts a BCCH signal with a stronger power according to a BCCH allocation list. After TMSI of the mobile subscriber is obtained, the communication-blocking device starts to monitor if there is a call to mobile subscriber. When the base station calls the mobile subscriber, the communication-blocking device sends blocking RAs in each RA time slot. Therefore, RA of the mobile subscriber and the blocking RA collide, so the mobile subscriber will not receive the call. The method of the present invention can block the mobile subscriber from receiving calls but allow the mobile subscriber to retain the function of initiating a call. Compared to the prior art, the present invention has the advantages of low cost, less complexity, and one-way blocking.

Those skilled in the art will readily observe that numerous modifications and alterations of the device and method may be made while retaining the teachings of the invention. Accordingly, the above disclosure should be construed as limited only by the metes and bounds of the appended claims.

1. A method of blocking communications used in a communication-blocking unit for preventing a base station from establishing communications with a mobile subscriber comprising:
(a) receiving a first BCCH signal emitted by the base station and reading system information from the BCCH signal;
(b) sending a second BCCH signal in a specific area according to the system information;
(c) collecting an identity of the mobile subscriber in the specific area; and
(d) receiving a CCCH signal, and if the CCCH signal has the identity, sending a blocking RA during a predetermined time.

2. The method of claim 1 wherein step (a) further comprises detecting the first BCCH from a plurality of BCCH in a PLMN.

3. The method of claim 2 wherein measured power of the first BCCH is stronger than that of other BCCH in the specific area.

4. The method of claim 1 wherein measured power of the second BCCH signal is stronger than that of the first BCCH signal.

5. The method of claim 4 wherein step (c) further comprises the mobile subscriber entering the specific area, detecting changes in received signals, and performing cell selection.

6. The method of claim 1 wherein step (c) further comprises performing synchronization according to a synchronous burst signal sent by the base station.

7. The method of claim 1 wherein in step (a) the system information comprises the LAI of the base station.

8. The method of claim 7 wherein the second BCCH signal comprises the LAI of the base station.

9. The method of claim 1 wherein in step (c) the identity is TMSI.

10. The method of claim 1 wherein step (d) further comprises the communication-blocking unit and the mobile subscriber sending a signal at the same predetermined time.

11. The method of claim 10 wherein the predetermined time comprises a plurality of RA time slots in a TDMA system.

12. The method of claim 11 wherein the times for which the mobile subscriber tries to connect to the base station are fewer than the number of RA time slots in which blocking signals are sent.

13. A communication-blocking device for preventing a base station from establishing communications with a mobile subscriber, the base station emitting a first BCCH signal and a CCCH signal, the communication-blocking device comprising:
a receiver for receiving the first BCCH signal and the CCCH signal;
a transmitter for sending a blocking signal;
a list storage module for storing a blocking list; and
a processing unit;
wherein when the mobile subscriber sends a TMSI to the base station, the processing unit stores the TMSI in the blocking list, and when the CCCH signal has the TMSI, the transmitter sends the blocking signal during a predetermined time.

14. The communication-blocking device of claim 13 wherein the transmitter sends a second BCCH signal in a specific area, the second BCCH signal corresponding to the first BCCH signal.

15. The communication-blocking device of claim 14 wherein measured power of the second BCCH signal is greater than that of the first BCCH signal in the specific area.

16. The communication-blocking device of claim 15 wherein when the mobile subscriber detects that measured power of the second BCCH signal is greater than that of the first BCCH signal, the mobile subscriber sends out the TMSI.

17. The communication-blocking device of claim 15 further comprising a power detecting module for detecting power of the first BCCH signal in order to adjust power of the second BCCH signal.

18. The communication-blocking device of claim 13 further comprising a logic determining module for determining that the transmitter sends the blocking signal according to the blocking list when the CCCH signal has the TMSI.

19. The communication-blocking device of claim 13 wherein the mobile subscriber sends a connection signal in an RA time slot in a TDMA system when receiving the CCCH signal which has the TMSI, the blocking signal and the connection signal belonging to the same time slot.

20. The communication-blocking device of claim 13 wherein the blocking signal is sent in a plurality of RA time slots of a TDMA system, the times for which the mobile subscriber tries to connect to the base station being fewer than the number of RA time slots in which blocking signals are sent.
